(19) United States
(12) Patent Application Publication
(10) Pub. No.: US 2026/0201670 A1
(43) Pub. Date: Jul. 16, 2026

(54) REAL-TIME WEIGHT COMPENSATION METHOD AND SYSTEM FOR AUTOMATIC SWING CONTROL OF CONSTRUCTION MACHINE

(71) Applicant: Volvo Construction Equipment AB, Eskilstuna (SE)

(72) Inventors: Gijun YOON, Gyeongsangnam-do (KR); Hoeryoung KWON, Gyeongsangnam-do (KR)

(21) Appl. No.: 19/443,128

(22) Filed: Jan. 8, 2026

(30) Foreign Application Priority Data
Jan. 14, 2025 (KR) 10-2025-0005578

(51) Int. Cl. E02F 3/43; E02F 3/32; E02F 9/26

(52) U.S. Cl. CPC E02F 3/439; E02F 9/265; E02F 3/32

(57) ABSTRACT

A real-time weight compensation method is disclosed for automatic swing control of a construction machine. The method comprises: measuring a current arm joint angle using one or more detection means, measuring a current boom cylinder pressure at the current arm joint angle using a pressure measuring means, calculating a pressure difference between the measured current boom cylinder pressure at the current arm joint angle and a preset reference boom cylinder pressure at the corresponding arm joint angle, converting the calculated pressure difference into a preset reference additional weight at the corresponding pressure difference, and updating a swing moment of inertia of the upper structure in real time by reflecting the reference additional weight.

### CROSS REFERENCE TO RELATED APPLICATIONS

This application claims priority to Korean Patent Application No. 10-2025-0005578, filed on Jan. 14, 2025, the disclosure and content of which is incorporated by reference herein in its entirety.

### TECHNICAL FIELD

The disclosure relates generally to a real-time weight compensation method and system for automatic swing control of construction machine. In particular aspects, the disclosure relates to method and system for reflecting in real time the change in weight due to replacement of an attachment or weight of work material to the swing moment of inertia of a construction machine. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

An excavator is a type of construction machine performing various tasks such as digging for digging up the grounds at construction sites and the like, transporting the excavated soil and loading it into a load receiver, excavating for making a foundation, crushing for dismantling buildings, grading for cleaning the ground, and leveling for leveling the ground or the like.

An excavator may generally comprise a lower traveling body that serves as a moving part of the equipment, an upper rotating body rotatably installed on the lower traveling body, and a work machine (boom, arm, bucket, and the like) installed at the front of the upper rotating body.

Generally, when an excavator performs a series of consecutive operations including digging and dumping, it alternates its swing direction left and right within a certain swing range. At this time, if the operator manually stops the upper rotating body during the swing process, the upper rotating body will stop at a certain point after swinging a certain angle from the moment the stop is initiated. However, the stopping point varies depending on when the stop command is initiated, making it difficult to stop precisely at the target point. Therefore, if there is an obstacle, the equipment must stop considerably in advance to avoid collisions, and there is also the inconvenience of the operator having to perform additional swing operations to hit the target point.

To solve this problem, an automatic swing control function called the Swing Boundary Limit (SBL) was introduced, which enables the upper rotating body to automatically stop at the target point set by the operator. However, the conventional swing boundary limit function does not account for external weights, such as the weight of excavated work material or the weight of work equipment replaced on site other than the preset weight condition of the excavator. In this case, even if the swing boundary limit function is activated, the upper rotating body may stop beyond the target point set by the operator, which may lead to a major accident.

### SUMMARY

The present disclosure is intended to address the problems of the prior art described above, and the purpose of the present disclosure is to provide a real-time weight compensation method and system for improving the accuracy of automatic swing control by reflecting in real time changes in weight caused by replacement of the work device or weight of the work material.

The first aspect of the present disclosure is a real-time weight compensation method for automatic swing control of a construction machine, wherein the construction machine comprises a lower traveling body and an upper structure swingably supported on the lower traveling body, the upper structure including an upper rotating body, a boom connected to the upper rotating body, an arm connected to the boom, and an attachment connected to the arm, the method comprising: measuring a current arm joint angle (θc) using one or more detection means, measuring a current boom cylinder pressure (Pc) at the current arm joint angle (θc) using a pressure measuring means, calculating a pressure difference (ΔP) between the measured current boom cylinder pressure (Pc) at the current arm joint angle (θc) and a preset reference boom cylinder pressure (Pr) at the corresponding arm joint angle (θc), converting the calculated pressure difference (ΔP) into a preset reference additional weight (Wr) at the corresponding pressure difference (ΔP), and updating a swing moment of inertia of the upper structure in real time by reflecting the reference additional weight (Wr).

Optionally, the method may be characterized in that the reference boom cylinder pressure (Pr) according to the arm joint angle is determined by linearly interpolating the boom cylinder pressure (P1) when the swing moment of inertia of the upper structure is minimum and the boom cylinder pressure (P2) when the swing moment of inertia of the upper structure is maximum with respect to the standard specifications of the construction machine.

Optionally, the method may be characterized in that the posture of the construction machine when the swing moment of inertia of the upper structure is minimum is a state in which the boom is pulled up, the arm is pulled in, and the attachment is pulled in, and the posture of the construction machine when the swing moment of inertia of the upper structure is maximum is a state in which the arm is pulled out, the attachment is pulled in, and the height of the first pin connecting the boom and the upper rotating body and the height of the second pin connecting the attachment and the arm are the same.

Optionally, the method may be characterized in that the pressure measuring means is installed on the boom cylinder.

Optionally, the method may be characterized in that the detection means is an inertial measurement unit (IMU) or an angle sensor.

Optionally, the method may be characterized in that, in the step of calculating the pressure difference (ΔP), if the pressure difference (ΔP) is calculated as a negative value, the pressure difference (ΔP) is output as 0.

Optionally, the method may be characterized in that the updated swing moment of inertia of the upper structure is applied to a swing boundary limit function that causes the swing of the upper structure to stop at a swing limit point set by the operator.

The second aspect of the present disclosure is a real-time weight compensation system for automatic swing control of a construction machine, wherein the construction machine comprises a lower traveling body and an upper structure swingably supported on the lower traveling body, the upper structure including an upper rotating body, a boom connected to the upper rotating body, an arm connected to the boom, and an attachment connected to the arm, one or more detection means for measuring the current arm joint angle (θc) in real time, a pressure measuring means for measuring the current boom cylinder pressure (Pc) at the current arm joint angle (θc) in real time, and a processor for performing real-time weight compensation based on the current arm joint angle (θc) and the current boom cylinder pressure (Pc), the processor: calculating a pressure difference (ΔP) between the measured current boom cylinder pressure (Pc) at the current arm joint angle (θc) and a predefined reference boom cylinder pressure (Pr) at the corresponding arm joint angle (θc), converting the calculated pressure difference (ΔP) into a preset reference additional weight (Wr) at the corresponding pressure difference (ΔP), and updating a swing moment of inertia of the upper structure in real time by reflecting the reference additional weight (Wr).

Optionally, the system may be characterized in that the reference boom cylinder pressure (Pr) according to the arm joint angle is determined by linearly interpolating the boom cylinder pressure (P1) when the swing moment of inertia of the upper structure is minimum and the boom cylinder pressure (P2) when the swing moment of inertia of the upper structure is maximum with respect to the standard specifications of the construction machine.

Optionally, the system may be characterized in that the posture of the construction machine when the swing moment of inertia of the upper structure is minimum is a state in which the boom is pulled up, the arm is pulled in, and the attachment is pulled in, and the posture of the construction machine when the swing moment of inertia of the upper structure is maximum is a state in which the arm is pulled out, the attachment is pulled in, and the height of the first pin connecting the boom and the upper rotating body and the height of the second pin connecting the attachment and the arm are the same.

Optionally, the system may be characterized in that the pressure measuring means is installed on the boom cylinder.

Optionally, the system may be characterized in that the detection means is an inertial measurement unit (IMU) or an angle sensor.

Optionally, the system may be characterized in that, if the pressure difference (ΔP) is calculated as a negative value, the processor output the pressure difference (ΔP) as 0.

Optionally, the system may be characterized in that the updated swing moment of inertia of the upper structure is applied to a swing boundary limit function that causes the swing of the upper structure to stop at a swing limit point set by the operator.

The third aspect of the present disclosure may provide a computer program product comprising program code for performing the method according to the first aspect when executed on a computer.

The fourth aspect of the present disclosure may provide a computer-readable storage medium comprising instructions for performing the method according to the first aspect when executed on a computer.

According to the present disclosure, when the weight of a construction machine changes due to replacement of an attachment or work material, work efficiency, accuracy, and stability can be improved by performing an immediate update on the changed weight in real time and reflecting it in the automatic swing control of the construction machine.

The effects of the present disclosure are not limited to the effects described above, but should be understood to include all effects that can be inferred from the detailed description of the present disclosure or the composition of the disclosure described in the claims.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a drawing illustrating a construction machine according to an aspect of the present disclosure.

FIG. 2 is a drawing for explaining automatic swing control of a construction machine according to an aspect of the present disclosure.

FIG. 3 is a flow chart of automatic swing control of a construction machine according to an aspect of the present disclosure.

FIG. 4 is a block diagram schematically illustrating the configuration of a real-time weight compensation system for automatic swing control of a construction machine according to an aspect of the present disclosure.

FIG. 5 is a flow chart of a real-time weight compensation method for automatic swing control of a construction machine according to an aspect of the present disclosure.

FIG. 6 is a drawing for explaining a real-time weight compensation method for automatic swing control of a construction machine according to an aspect of the present disclosure.

FIG. 7 is a drawing showing a real-time weight compensation algorithm for automatic swing control of a construction machine according to an aspect of the present disclosure.

FIG. 8 is a block diagram schematically illustrating the configuration of a real-time weight compensation system for automatic swing control of a construction machine according to another aspect of the present disclosure.

FIG. 9 is a drawing showing a real-time weight compensation algorithm for automatic swing control of a construction machine according to another aspect of the present disclosure.

### DETAILED DESCRIPTION

The detailed description sets forth below provides information and examples of the disclosed technology with sufficient detail to enable those skilled in the art to practice the disclosure.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; Rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

Hereinafter, one aspect of the present disclosure will be described in detail with reference to the attached drawings.

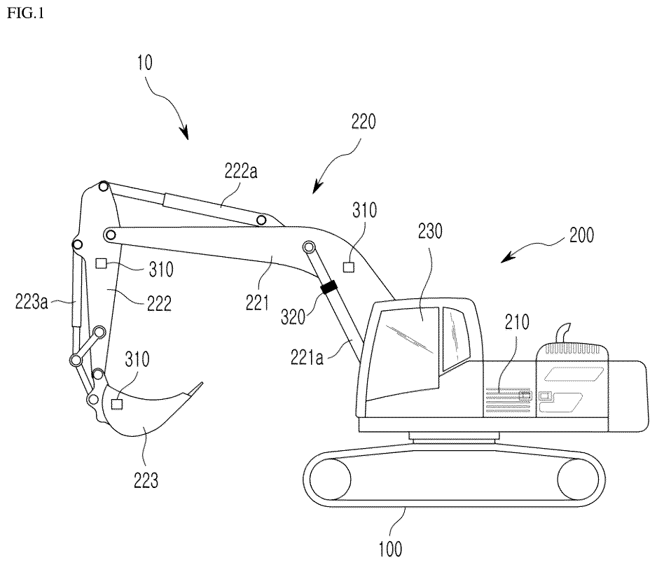

FIG. 1 is a drawing illustrating a construction machine according to an aspect of the present disclosure.

Referring to FIG. 1, a construction machine 10 according to one aspect of the present disclosure may be, for example, an excavator. The present disclosure may be described with respect to an excavator, but is not limited thereto. An excavator is equipment capable of excavating target object, and may include various forms of excavators that can perform excavation work in various ways, such as soil transport work, building dismantling work, ground leveling work and the like.

A construction machine 10 may include a lower traveling body 100 and an upper structure 200 that is supported so as to be able to swing on the lower traveling body 100. The upper structure 200 may include an upper rotating body 210 and a work device 220. The working device 220 may include, for example, a boom 221, an arm 222 and an attachment 223. The attachment 223 may be, for example, a bucket.

The lower traveling body 100 is configured to support the load of the work device 220 including the upper rotating body 210, boom 221, arm 222, and attachment 223 while moving the construction machine 10. The lower traveling body 100 includes a pair of left and right traveling units, and can drive in a straight line in the forward and backward direction, turn left and right by steering, or turn in the opposite direction of traveling.

The upper rotating body 210 is configured to be supported on the lower traveling body 100 and is designed to swing on the lower traveling body 100 by a rotating device including a swing motor, a swing reduction gear, and the like.

The upper rotating body 210 may be equipped with an operator's cabin 230 of a construction machine 10, and the operator's cabin 230 may be provided with an operator's seat where the operator can sit. In front of the operator's seat, various operating levers or pedals for controlling the operation or travel of the construction machine 10 may be provided, and a swing lever may also be provided so that the operator can control the swing of the upper rotating body 210.

The arm 222 is connected to the attachment 223 and the boom 221, respectively, and in one embodiment, the boom 221, the arm 222 and the attachment 223 are connected in that order from the upper rotating body 210 through joints, and each joint can be moved by a hydraulic cylinder.

For example, the arm 222 may be connected to the boom 221 that is connected to the upper rotating body 210 at one end and may be connected to the attachment 223 at the other end. Each of the boom 221, the arm 222 and the attachment 223 can be rotated about one or more axes by the boom cylinder 221a, the arm cylinder 222a and the attachment cylinder 223a, and the attachment 223, for example, the bucket, can hold an excavation target object (e.g., soil) on the ground inside as it rotates.

Since the boom 221, arm 222 and attachment 223 are installed while being supported toward the front on the upper rotating body 210, when the upper rotating body 210 swings, the boom 221, arm 222 and attachment 223 swing together with the upper rotating body 210.

The construction machine 10 may be configured with, for example, an electro-hydraulic system, and its drive may be electronically controlled by a controller.

Meanwhile, if the operator does not pay sufficient attention during the swing process of the upper structure 200 including the upper rotating body 210, the work device 220 and the operator's cabin 230, an accident such as the work device 220 colliding with a nearby obstacle or worker may occur. Additionally, as needed, when the work device 220 performs a series of consecutive operations including digging and dumping, it performs repetitive operations by alternating its swing direction left and right within a certain swing range. At this time, precise swing motion is required for work efficiency.

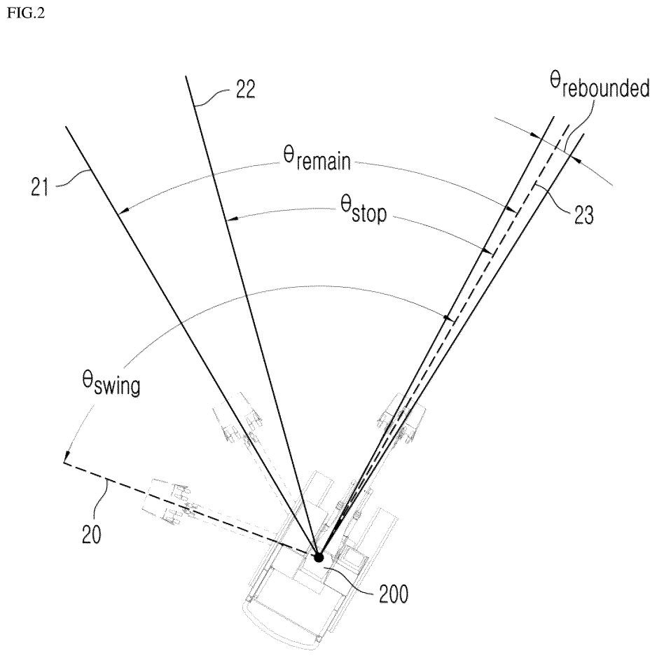

FIG. 2 is a drawing for explaining automatic swing control of a construction machine according to an aspect of the present disclosure.

The automatic swing control of a construction machine according to one aspect of the present disclosure may be a Swing Boundary Limit (SBL) function that enables the swing of the upper structure to be automatically stopped at a target swing point set by an operator. The target swing point (or swing limit point) set by the operator may be, for example, a digging point for digging work material or a loading point for loading excavated work material.

When a target swing point is set by the operator, the controller of the construction machine outputs a control signal to the rotating device so that the swing of the upper structure stops at a location corresponding to the target swing point. At this time, regardless of whether the operator operated the swing lever in the operator's cabin, the controller outputs a control signal to the rotating device to prevent the upper structure from passing the location set as the target swing point. That is, when the target swing point is set, the swing of the upper structure stops at the location set as the target swing point, and the upper structure cannot swing beyond the location set as the target swing point even by the operator's operation of the swing lever.

For example, referring to FIG. 2, in the swing boundary limit (SBL) function, the swing start point 20 is the point where the swing of the upper structure 200 begins, the target swing point 23 is the point where the swing of the upper structure 200 stops set by the operator, the current swing point 21 is the point where the swinging upper structure 200 is currently located, and the braking start point 22 is the point where the upper structure 200 must start braking to stop at the target swing point 23. That is, the angle from the swing start point 20 to the target swing point 23 can be defined as the target swing angle (θ_{swing}), the angle from the current swing point 21 to the target swing point 23 can be defined as the remaining angle (θᵣₑₘₐᵢₙ), and the angle from the braking start point 22 to the target swing point 23 can be defined as the braking angle (θₛₜₒₚ). Additionally, the angle caused by the bounce phenomenon due to the inertia of the upper structure 200, the compressibility of the fluid, and the backlash of the slewing gear can be defined as the rebound angle (θ_{rebounded}).

Here, the controller of the construction machine automatically controls the swing so that the upper structure 200 can stop at the swing target point 23 while comparing the remaining angle (θᵣₑₘₐᵢₙ) and the braking angle (θₛₜₒₚ) from the current swing point 21 to the swing target point 23 in real time.

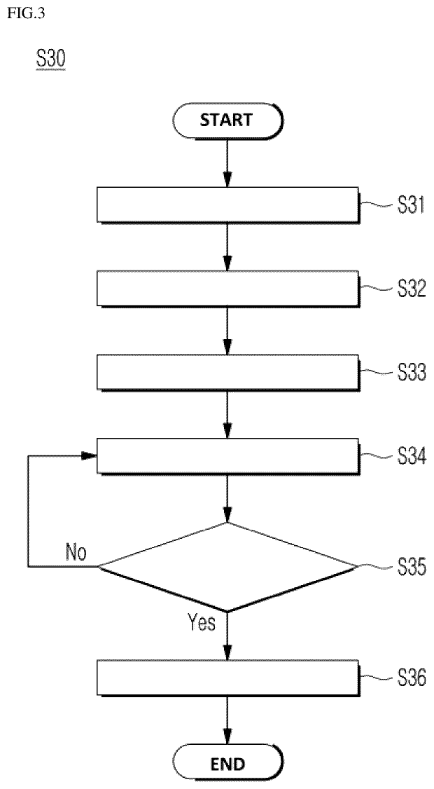

FIG. 3 is a flow chart of automatic swing control of a construction machine according to an aspect of the present disclosure.

Referring to FIG. 3, the automatic swing control method S30 of a construction machine may comprise activating a swing boundary limit (SBL) function S31, setting a target swing point (target swing angle) S32, calculating a remaining swing angle between a current swing point and a target swing point S33, calculating a braking angle S34, comparing the remaining swing angle with the braking angle S35, and restricting swing lever operation and initiating deceleration if the remaining swing angle is less than or equal to the braking angle S36.

Here, in the step of calculating the braking angle S34, the braking angle can be calculated based on the swing moment of inertia of the upper structure, the current swing angular velocity of the upper structure, and the swing dynamic braking torque by the swing motor, as follows.

$$Braking angle ∝ \frac{Swing moment of inertia \times Swing angular {velocity}^{2}}{Swing dynamic braking torque}$$

That is, if the weight of the upper structure increases due to replacement of the work device or work material, the swing moment of inertia of the upper structure increases, and further, the rotational kinetic energy increases, so the braking angle required to stop the swing of the upper structure increases.

At this time, in the swing boundary limit (SBL) function, if the weight changed by the replacement of attachments or work materials, especially the increased weight, is not reflected, a difference in the braking angle to stop the upper structure at the target swing point occurs, which makes it impossible to guarantee the accurate performance of the swing boundary limit (SBL). Therefore, it is necessary to update the weight changed by attachment replacement or work material in real time and account for it in the calculation of the swing moment of inertia of the upper structure to ensure accurate performance of the swing boundary limit (SBL).

Meanwhile, in the step of limiting the swing lever operation and starting deceleration S36, the section in which the remaining swing angle (θᵣₑₘₐᵢₙ) is less than or equal to the braking angle (θₛₜₒₚ) is defined as a swing braking section, and during the swing braking operation, the operation of the work device lever can also be limited so that the swing moment of inertia does not increase. That is, when the remaining swing angle (θᵣₑₘₐᵢₙ) is less than or equal to the braking angle (θₛₜₒₚ), even if an operation signal of the swing lever is input in the current swing traveling direction, the controller does not accept the operation signal of the swing lever in order to stop at the swing target point.

That is, if the swing moment of inertia increases due to operation of the work device (e.g., arm out operation) during the swing braking operation, a problem may occur in which the upper structure cannot stop at the target swing point and goes beyond the target swing point, and in order to prevent this problem, operation of the work device (e.g., arm out operation) may also be restricted during the swing braking section.

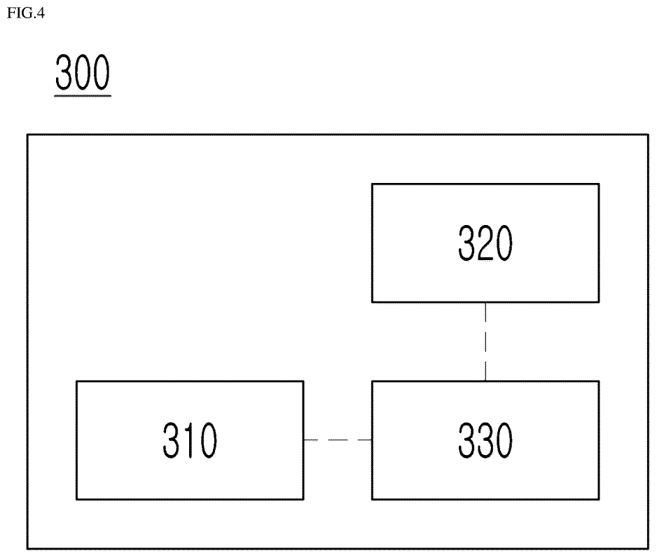

FIG. 4 is a block diagram schematically illustrating the configuration of a real-time weight compensation system for automatic swing control of a construction machine according to an aspect of the present disclosure.

A real-time weight compensation system 300 for automatic swing control of a construction machine of which weight has changed due to replacement of an attachment or work material according to one aspect of the present disclosure may comprise one or more detection means 310, pressure measuring means 320, and processor 330.

The detection means 310 is installed in the work device 220 and can detect information about the position, angle, and the like of the work device 220. In particular, the detection means 310 can measure the current arm joint angle (θ_{c}) in real time. Here, the arm joint angle (θ_{c}) refers to the angle between the arm 222 and the boom 221.

According to one embodiment, the detection means 310 may be an Inertial Measurement Unit (IMU). One or more inertial measurement units may be installed on each of the boom 221, the arm 222 and the attachment 223. One or more inertial measurement units may include three accelerometers for measuring linear motion and three gyrometers for measuring rotational motion, and may measure the direction of motion, posture, location, speed, and the like of the work device 220.

According to another embodiment, the detection means 310 may be an angle sensor. One or more angle sensors may be installed on each of the boom 221, the arm 222 and the attachment 223.

One or more angle sensors can measure the position and angle of the boom 221, the position and angle of the arm 222, and the position and angle of the attachment 223.

In this way, the detection means 310 can detect information about the position, angle, and the like of the work device 220 required for real-time weight compensation.

The pressure measuring means 320 can measure the current boom cylinder pressure (P_{c}) at the current arm joint angle (θ_{c}) in real time. The pressure measuring means 320 may be installed in the large chamber of the boom cylinder. The pressure measuring means 320 may be, for example, a pressure sensor.

The pressure measuring means 320 is installed in the large chamber of the boom cylinder and can output data of an electrical signal or a physical pressure signal corresponding to a change in cylinder pressure.

Information obtained from the detection means 310 and the pressure measuring means 320 may be transmitted to the processor 330 via wired communication, for example, CAN (Controller Area Network), LIN (Local Interconnect Network), FlexRay, or the like. Alternatively, information obtained from the detection means 310 and the pressure measuring means 320 may be transmitted to the processor 330 via wireless communication, for example, Wi-Fi, Bluetooth, Zigbee, 5G, or the like.

The processor 330 receives the measured current arm joint angle (θ_{c}) and the current boom cylinder pressure (P_{c}), and can use these to estimate the changed weight (e.g., bucket load added by work material).

That is, the processor 330 can update in real time the weight of the attachment, which are changed by replacement of the attachment or work material, and the swing moment of inertia of the upper structure based on the current arm joint angle (θ_{c}) and the current boom cylinder pressure (P_{c}) from the detection means 310 and the pressure measuring means 320. Such a processor 330 can operate with the swing boundary limit (SBL) function activated.

More specifically, the processor 330 may calculate a pressure difference (ΔP) between the measured current boom cylinder pressure (P_{c}) at the current arm joint angle (θ_{c}) and a preset reference boom cylinder pressure (Pᵣ) at the current arm joint angle (θ_{c}), convert the calculated pressure difference (ΔP) into a preset reference additional weight (Wᵣ) at the corresponding pressure difference (ΔP), and update the swing moment of inertia of the upper structure in real time by reflecting the reference additional weight (Wᵣ).

In other words, the real-time weight compensation system 300 for automatic swing control can guarantee the performance of the swing boundary limit (SBL) by estimating and compensating in real time the weight added during the operation of the construction machine using the measuring means 310 and the pressure measuring means 320.

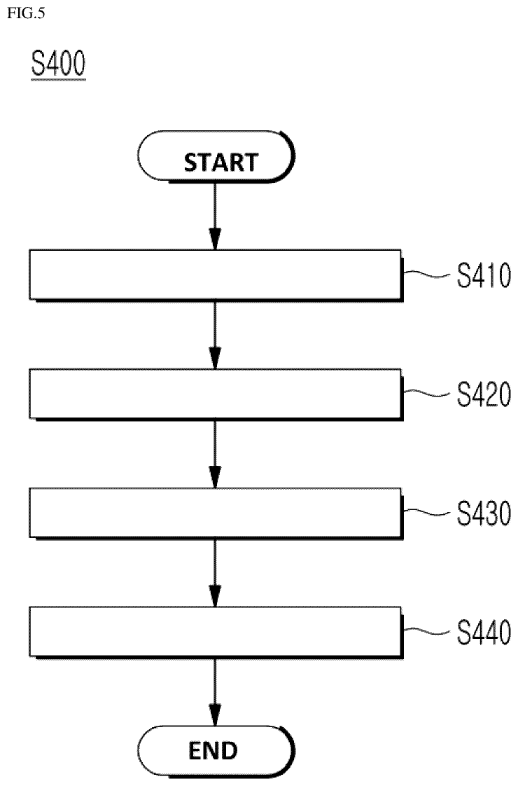

The above-described series of consecutive weight compensation methods will be described in detail later with reference to FIGS. 5 to 7.

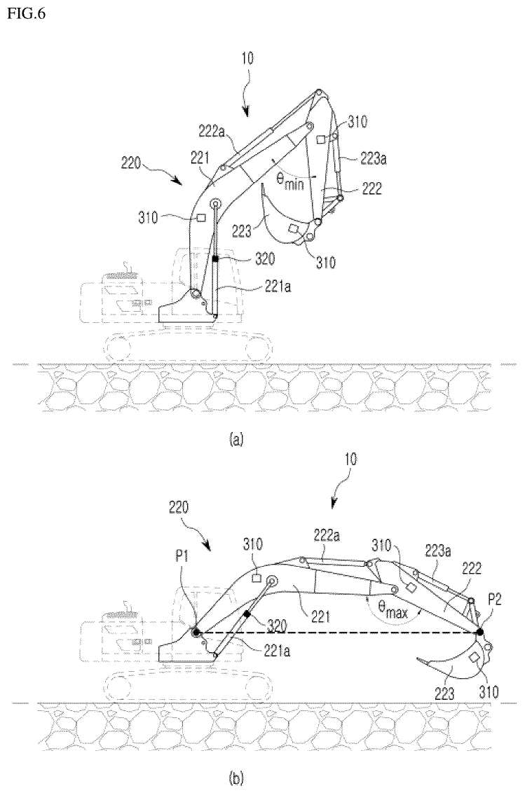

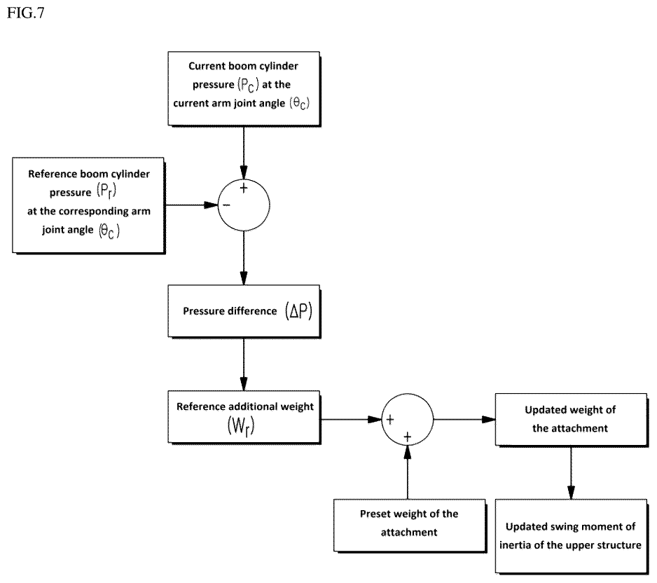

FIG. 5 is a flow chart of a real-time weight compensation method for automatic swing control of a construction machine according to an aspect of the present disclosure, FIG. 6 is a drawing for explaining a real-time weight compensation method for automatic swing control of a construction machine according to an aspect of the present disclosure, and FIG. 7 is a drawing showing a real-time weight compensation algorithm for automatic swing control of a construction machine according to an aspect of the present disclosure.

Referring to FIGS. 5 to 7, a real-time weight compensation method for automatic swing control of a construction machine whose weight has changed due to replacement of an attachment or work material S410 may comprise: measuring a current arm joint angle (θc) using one or more detection means and measuring a current boom cylinder pressure (P_{c}) at the current arm joint angle (θc) using a pressure measuring means S410, calculating a pressure difference (ΔP) between the measured current boom cylinder pressure (P_{c}) at the current arm joint angle (θc) and a preset reference boom cylinder pressure (Pᵣ) at the corresponding arm joint angle (θc) S420, converting the calculated pressure difference (ΔP) into a preset reference additional weight (Wᵣ) at the corresponding pressure difference (ΔP), and updating a swing moment of inertia of the upper structure in real time by reflecting the reference additional weight (Wᵣ).

Referring to FIGS. 5 to 7, in step S410, one or more detection means 310 can measure the current arm joint angle (θ_{c}) in real time, and the pressure measuring means 320 can measure the current boom cylinder pressure (P_{c}) at the current arm joint angle (θ_{c}) in real time.

In step S420, the processor 330 can calculate a pressure difference (ΔP) between the measured current boom cylinder pressure (P_{c}) at the current arm joint angle (θ_{c}) and the preset reference boom cylinder pressure (Pᵣ) at the corresponding arm joint angle (θ_{c}).

Here, the reference boom cylinder pressure (Pᵣ) according to the arm joint angle can be determined by linearly interpolating the boom cylinder pressure (P1) when the swing moment of inertia of the upper structure is minimum and the boom cylinder pressure (P2) when the swing moment of inertia of the upper structure is maximum with respect to the standard specifications of the construction machine (the specifications at the time of shipment of the construction machine). The arm joint angle when the swing moment of inertia of the upper structure is minimum can be minimum (θₘᵢₙ), and the arm joint angle when the swing moment of inertia of the upper structure is minimum can be maximum (θₘₐₓ). For example, by linearly interpolating two points (θₘᵢₙ, P1) and (θₘₐₓ, P2) on a graph representing reference boom cylinder pressures according to the arm joint angle, the reference boom cylinder pressure (Pᵣ) at a specific arm joint angle located between θₘᵢₙ and θₘₐₓ can be determined. The reference boom cylinder pressure (Pᵣ) at this specific arm joint angle may be preset and stored in the system.

Referring to FIG. 6, the posture of the construction machine 10 when the swing moment of inertia of the upper structure is minimum may be a pull-up state of the boom 221, a pull-in state of the arm 222, and a pull-in state of the attachment 223 (e.g., bucket) ((a) of FIG. 6, short reach posture). In other words, when the construction machine 10 is in a short reach posture, the swing moment of inertia of the upper structure may be at a minimum. Further, the posture of the construction machine when the swing moment of inertia of the upper structure is maximum may be a state in which the arm 222 is pulled out, the attachment 223 (e.g., bucket) is pulled in, and the height of the first pin (P1) connecting the boom 221 and the upper rotating body 210 and the height of the second pin (P2) connecting the attachment 223 (e.g., bucket) and the arm 222 are identical ((b) of FIG. 6, full reach posture). In other words, when the construction machine 10 is in a full reach posture, the swing moment of inertia of the upper structure may be at a maximum.

Meanwhile, the pressure difference (ΔP) may be defined as the current boom cylinder pressure (P_{c}) minus the reference boom cylinder pressure (Pᵣ). That is, if the pressure difference (ΔP) is calculated as a positive value, it may mean that the current boom cylinder pressure (P_{c}) is greater than the reference boom cylinder pressure (Pᵣ), which may mean that the weight of the attachment has increased (e.g., increased bucket load due to work material). Further, if the pressure difference (ΔP) is calculated as a negative value, it may mean that the current boom cylinder pressure (P_{c}) is less than the reference boom cylinder pressure (Pᵣ), which may mean that the weight of the attachment has decreased (e.g., replacement with a lighter attachment). However, if the pressure difference (ΔP) is calculated as a negative value, the processor 330 may output the pressure difference (ΔP) as 0. However, if the pressure difference (ΔP) calculated as a negative value is output as is, it has the effect of stopping the upper structure before the swing target point.

In step S430, the processor 330 can convert the calculated pressure difference (ΔP) into a preset reference additional weight (Wᵣ) at the corresponding pressure difference (ΔP).

The reference additional weight (Wᵣ) may be preset and stored in the system. For example, when the pressure difference (ΔP) is 0, the reference additional weight (Wᵣ) may be set to 0, when the pressure difference (ΔP) is 55, the reference additional weight (Wᵣ) may be set to the bucket standard load, and when the pressure difference (ΔP) is 100, the reference additional weight (Wᵣ) may be set to twice the bucket standard load. In other words, the processor 330 can convert the calculated pressure difference (ΔP) into a preset reference additional weight (Wᵣ) corresponding to that pressure difference (ΔP).

In step S440, the processor 330 can update the swing moment of inertia of the upper structure in real time by reflecting the reference additional weight (Wᵣ). That is, the processor 330 can update the weight of the attachment by adding the reference additional weight (Wᵣ) to the preset attachment weight, and update the swing moment of inertia of the upper structure in real time by reflecting the updated weight of the attachment.

That is, the updated swing moment of inertia of the upper structure can be calculated based on the pressure difference (ΔP) between the current boom cylinder pressure (P_{c}) measured by the pressure measuring means and the preset reference boom cylinder pressure (Pᵣ), and the preset reference additional weight (Wᵣ).

The real-time updated swing moment of inertia of the upper structure can applied to a swing boundary limit (SBL) function that causes the swing of the upper structure to stop at a target swing point set by the operator. For example, in step S34 of calculating the braking angle of FIG. 3, the braking angle can be calculated more accurately using the real-time updated swing moment of inertia of the upper structure. In other words, by updating the weight of the attachment changed by attachment replacement or work material in real time and accounting for it in the calculation of the swing moment of inertia of the upper structure, the accurate performance of the swing boundary limit (SBL) can be ensured.

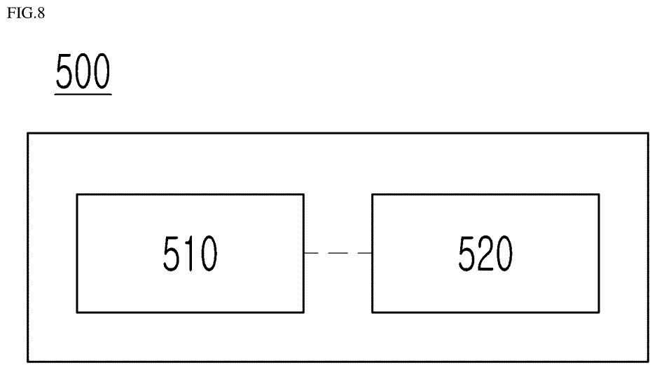

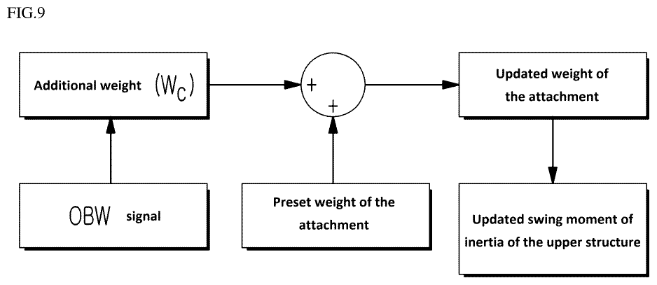

FIG. 8 is a block diagram schematically illustrating a configuration of a real-time weight compensation system for automatic swing control of a construction machine according to another aspect of the present disclosure, and FIG. 9 is a drawing illustrating a real-time weight compensation algorithm for automatic swing control of a construction machine according to another aspect of the present disclosure.

Referring to FIGS. 8 and 9, a real-time weight compensation system 500 for automatic swing control of a construction machine according to another aspect of the present disclosure may include an OBW system 510 and a processor 520.

The OBW (On Board Weighing) system 510 refers to a system that measures and monitors the weight of work materials loaded on an attachment in real time. The OBW (On Board Weighing) system 510 can measure the weight of loaded work materials in real time during work, allowing the operator to easily manage the loading amount and prevent overloading.

The OBW system 510 may include a load cell and a display device.

A load cell is a device that measures the load applied to an attachment, capable of detecting weight changes and converting it into an electrical signal. This load cell is installed at the connection point between the attachment and the arm, and can measure the weight of the work materials loaded on the attachment in real time.

A display device can visually provide real-time measured weight information to the operator. In addition to weight, the display device may display other work-related information, such as load capacity, warning messages, or the like.

The processor 520 can update the swing inertia moment of the upper structure in real time by reflecting the real-time weight information of the work materials received from the OBW system 510. That is, the processor 520 can update the weight of the attachment by adding the real-time weight of the work materials received from the OBW system 510, i.e., the additional weight (W_{c}) to the preset attachment weight, and update the swing moment of inertia of the upper structure in real time by reflecting the updated weight of the attachment.

In other words, the updated swing moment of inertia of the upper structure can be calculated based on the weight of the work materials loaded on the attachment received from the OBW system, i.e., the additional weight (W_{c}).

Various embodiments of the present disclosure may be implemented as software including one or more instructions saved in a storage medium (e.g., a memory) readable by a machine (e.g., a display device or a computer). For example, a processor of the machine may call at least one instruction from one or more instructions saved from a storage medium and execute it. This enables the machine to be operated to perform at least one function in accordance with at least one instruction called above. The one or more instructions may include codes generated by a compiler or codes executable by an interpreter. The machine-readable storage medium may be provided in the form of a non-transitory storage medium. Here, ‘non-transitory’ simply means that the storage medium is a tangible apparatus and does not contain signals (e.g. electromagnetic waves), and the term does not distinguish between cases where data is saved semi-permanently or temporarily on the storage medium.

According to an embodiment, the methods according to various embodiments disclosed in the present disclosure may be provided as included in a computer program product. The computer program product may be traded between sellers and buyers as a commodity. The computer program product may be distributed in the form of a machine-readable storage medium (e.g., a compact disc read only memory (CD-ROM)), or may be distributed online (e.g., by downloading or uploading) via an application store (e.g., Play Store™) or directly between two user devices (e.g., smartphones). In the case of online distribution, at least some of the computer program product may be temporarily saved or temporarily generated in a machine-readable storage medium, such as the memory of a manufacturer's server, an application store's server, or an intermediary server.

In this way, according to the present disclosure, when the weight of a construction machine changes due to replacement of an attachment or work material, work efficiency, accuracy, and stability can be improved by performing an immediate update on the changed weight in real time and reflecting it in the automatic swing control of the construction machine.

It should be understood that the present disclosure is not limited to the embodiments described above and illustrated in the drawings. Rather, those of ordinary skill in the art will recognize that many changes and modifications can be made within the scope of the present disclosure and the appended claims. In the drawings and specification, aspects are disclosed for illustrative purposes only and not for purposes of limitation, and the scope of the present disclosure is set forth in the claims below.

DESCRIPTION OF THE NUMERAL REFERENCES

| | |
|---|---|
| 10 | construction machine |
| 100 | lower traveling body |
| 200 | upper structure |
| 210 | upper rotating body |
| 220 | work device |
| 221 | boom |
| 221a | boom cylinder |
| 222 | arm |
| 222a | arm cylinder |
| 223 | attachment |
| 223a | attachment cylinder |
| 230 | operator's cabin |
| 300 | real-time weight compensation system for automatic swing control |
| | of construction machine according to the first embodiment |
| 310 | detection means |
| 320 | pressure measuring means |
| 330 | processor |
| 500 | real-time weight compensation system for automatic swing control |
| | of construction machine according to the second embodiment |
| 510 | OBW system |
| 520 | processor |

1. A real-time weight compensation method for automatic swing control of a construction machine, wherein the construction machine comprises a lower traveling body and an upper structure that is swingably supported on the lower traveling body, and the upper structure includes an upper rotating body, a boom connected to the upper rotating body, an arm connected to the boom, and an attachment connected to the arm, comprising:
measuring a current arm joint angle using one or more detection means, and measuring a current boom cylinder pressure at the current arm joint angle using a pressure measuring means;
calculating a pressure difference between the measured current boom cylinder pressure at the current arm joint angle and the preset reference boom cylinder pressure at the corresponding arm joint angle;
converting the calculated pressure difference into a predefined reference additional weight at the corresponding pressure difference; and
updating the swing moment of inertia of the upper structure in real time by reflecting the reference additional weight.

2. The method of claim 1,
characterized in that the reference boom cylinder pressure according to the arm joint angle is determined by linearly interpolating the boom cylinder pressure when the swing moment of inertia of the upper structure is minimum and the boom cylinder pressure when the swing moment of inertia of the upper structure is maximum with respect to the standard specifications of the construction machine.

3. The method of claim 2,
characterized in that the posture of the construction machine when the arm joint angle is minimum is a state in which the boom is pulled up, the arm is pulled in, and the attachment is pulled in, and
the posture of the construction machine when the arm joint angle is maximum is a state in which the arm is pulled out, the attachment is pulled in, and the height of the first pin connecting the boom and the upper rotating body and the height of the second pin connecting the attachment and the arm are the same.

4. The method of claim 1,
characterized in that the pressure measuring means is installed on the boom cylinder.

5. The method of claim 1,
characterized in that the detection means is an inertial measurement unit or an angle sensor.

6. The method of claim 1,
characterized in that, in calculating the pressure difference,
if the pressure difference is calculated as a negative value, the pressure difference is output as 0.

7. The method of claim 1,
characterized in that the updated swing moment of inertia of the upper structure is applied to a swing boundary limit function that causes the swing of the upper structure to stop at a swing limit point set by the operator.

8. A real-time weight compensation system for automatic swing control of a construction machine, wherein the construction machine comprises a lower traveling body and an upper structure that is swingably supported on the lower traveling body, and the upper structure includes an upper rotating body, a boom connected to the upper rotating body, an arm connected to the boom, and an attachment connected to the arm, comprising:
one or more detection means for measuring a current arm joint angle in real time;
a pressure measuring means for measuring a current boom cylinder pressure at the current arm joint angle in real time; and
a processor for performing real-time weight compensation based on the current arm joint angle and the current boom cylinder pressure,
wherein the processor calculates a pressure difference between the measured current boom cylinder pressure at the current arm joint angle and a predefined reference boom cylinder pressure at the corresponding arm joint angle;
converts the calculated pressure difference into a predefined reference additional weight at the corresponding pressure difference; and
updates the swing moment of inertia of the upper structure in real time by reflecting the reference additional weight.

9. The system of claim 8,
characterized in that the reference boom cylinder pressure according to the arm joint angle is determined by linearly interpolating the boom cylinder pressure when the swing moment of inertia of the upper structure is minimum and the boom cylinder pressure when the swing moment of inertia of the upper structure is maximum with respect to the standard specifications of the construction machine.

10. The system of claim 9,
characterized in that the posture of the construction machine when the swing moment of inertia of the upper structure is minimum is a state in which the boom is pulled up, the arm is pulled in, and the attachment is pulled in, and
the posture of the construction machine when the swing moment of inertia of the upper structure is maximum is a state in which the arm is pulled out, the attachment is pulled in, and the height of the first pin connecting the boom and the upper rotating body and the height of the second pin connecting the attachment and the arm are the same.

11. The system of claim 8,
characterized in that the pressure measuring means is installed on the boom cylinder.

12. The system of claim 8,
characterized in that the detection means is an inertial measurement unit (IMU) or an angle sensor.

13. The system of claim 8,
characterized in that the processor,
if the pressure difference is calculated as a negative value, outputs the pressure difference as 0.

14. The system of claim 8,
characterized in that the updated swing moment of inertia of the upper structure is applied to a swing boundary limit function that causes the swing of the upper structure to stop at a swing limit point set by the operator.

15. A computer program product comprising program code for performing the method of claim 1 when executed on a computer.

16. A computer-readable storage medium comprising instructions that, when executed on a computer, cause the method of claim 1 to be performed.
